(19) United States
(12) Patent Application Publication
(10) Pub. No.: US 2011/0296479 A1
(43) Pub. Date: Dec. 1, 2011

(54) Video Processor and Video Processing Method

(76) Inventors: Shinichiro NAKANO, Kawasaki-shi (JP); Yasuhiro FUJIYOSHI, Ome-shi (JP)

(21) Appl. No.: 13/072,446

(22) Filed: Mar. 25, 2011

(30) Foreign Application Priority Data
May 26, 2010 (JP) 2010-120244

(51) Int. Cl. H04N 7/173

(52) U.S. Cl. 725/109

(57) ABSTRACT

In one embodiment, there is provided a video processor that includes: an access module configured to access a Web site on internet; an analyzing module configured to analyze information about the Web site so as to calculate processing load for displaying the Web site; and a display controller configured to switch between a first display mode and a second display mode depending on the processing load, wherein only the Web site is displayed in the first display mode, and wherein both the Web site and a certain image are displayed together in the second display mode.

This application claims priority from Japanese Patent Application No. 2010-120244, filed on May 26, 2010, the entire contents of which are hereby incorporated by reference.

### BACKGROUND

1. Field

Embodiments described herein generally relate to a video processor and a video processing method.

2. Description of the Related Art

In the related-art video processors, a broadcasting signal transmitted from a broadcasting station is received so that a broadcasting program can be viewed, and furthermore, a browser is installed so that a Web site on internet can be browsed or contents such as movies or music can be downloaded.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a view showing a video processor according to a first embodiment;

FIG. 2 is a diagram showing the configuration of the video processor according to the first embodiment;

FIG. 3 is a flowchart to explain operations of the video processor according to the first embodiment;

FIGS. 4A to 4C are views showing screen display modes (a full-screen display mode and a dual-screen display mode);

FIG. 5 is a diagram showing the configuration of a video processor according to a second embodiment;

FIG. 6 is a flowchart to explain operations of the video processor according to the second embodiment; and

FIG. 7 is a flowchart showing operations of a video processor according to a third embodiment.

### DETAILED DESCRIPTION

According to exemplary embodiments of the present invention, there is provided a video processor that includes: an access module configured to access a Web site on internet; an analyzing module configured to analyze information about the Web site so as to calculate processing load for displaying the Web site; and a display controller configured to switch between a first display mode and a second display mode depending on the processing load, wherein only the Web site is displayed in the first display mode, and wherein both the Web site and a certain image are displayed together in the second display mode.

Hereinafter, an embodiment according to the invention will be described below in detail with reference to the drawings.

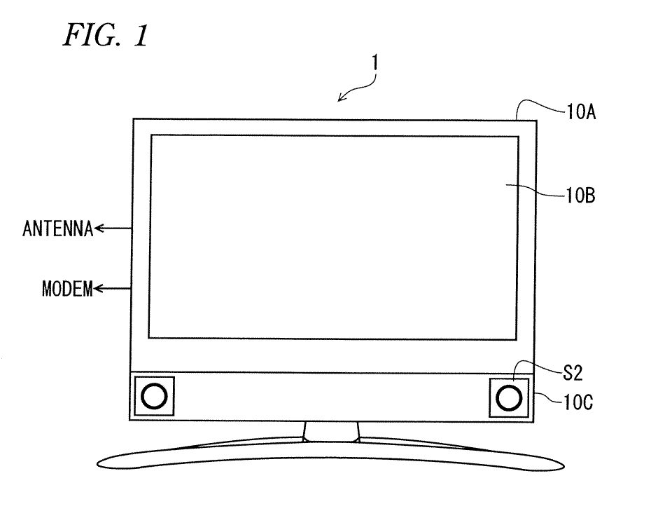

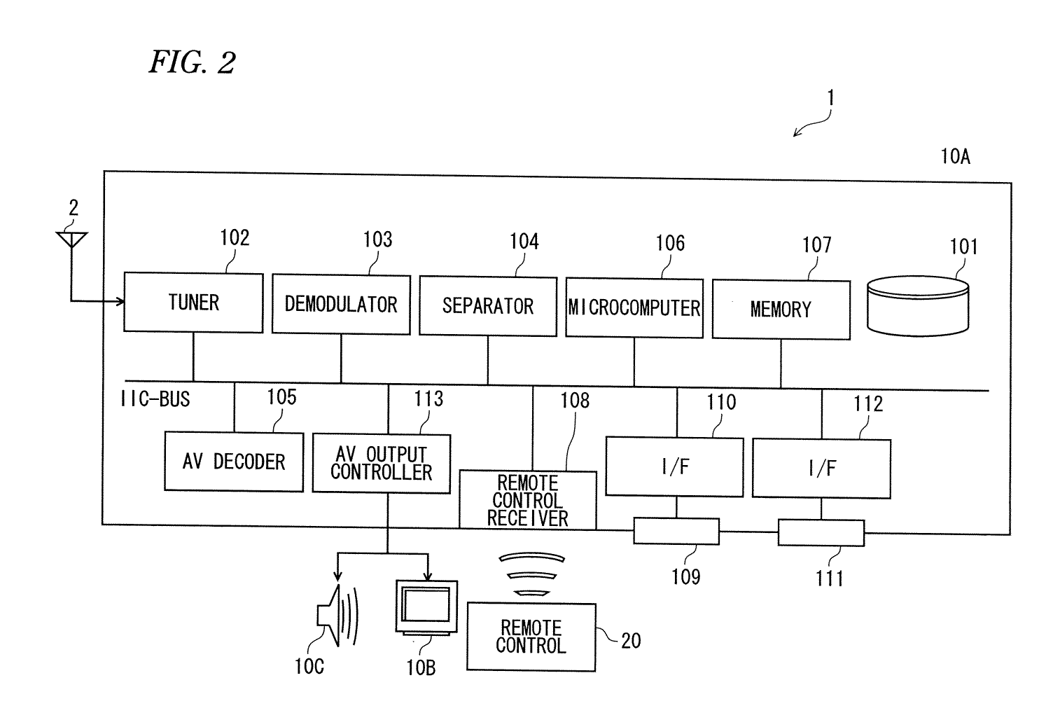

FIG. 1 is a view showing a video processor according to a first embodiment. FIG. 2 is a diagram showing the configuration of the video processor according to the first embodiment. In the first embodiment, description will be given to a digital television 1 (hereinafter referred to as a digital TV 1) as a specific example of the video processor.

In the digital TV 1 according to the first embodiment, a broadcasting signal transmitted from a broadcasting station is received so that a broadcasting program can be viewed and recorded, and furthermore, a browser is installed so that a Web site on interne can be browsed and contents such as movies or music can be downloaded and viewed.

The digital TV 1 includes an STB (Set Top Box) 10A, a display module 10B and an audio output module 10C. The STB 10A is configured to receive broadcasting signals of terrestrial television broadcasting (digital broadcasting), and then convert the broadcasting signals into signals which can be viewed by the display module 10B. Also, the STB 10A may be configured to receive broadcasting signals of cable television broadcasting, satellite broadcasting, terrestrial television broadcasting (analog broadcasting) or IP broadcasting (broadband VOD (video on demand)) in addition to the terrestrial television broadcasting (digital broadcasting).

The STB 10A includes an HDD 101, a tuner 102, a demodulator 103, a separator 104, an AV decoder 105, a microcomputer 106, a memory 107, a remote control receiver 108, a terminal 109, an I/F 110, a terminal 111, an I/F 112, and an AV output controller 113.

The HDD (Hard Disk Drive) 101 stores last channel information (information about the last selected channel), a recorded digital broadcasting program, EPG information (electronic program information), past EPG information, contents such as movies or a music which are downloaded from a Web server connected to the interne, and a URL (Uniform Resource Locator) of a homepage or a Web site which is registered as favorite.

The past EPG information indicates EPG information about a recorded broadcasting program. Moreover, it is also possible to use an SSD (Solid State Drive) utilizing a flash memory in place of the HDD 101. Furthermore, the last channel information may be stored in the memory 107 which will be described below.

The tuner 102 selects a desirable channel from a digital broadcasting signal received through an antenna 2. The demodulator 103 demodulates the digital broadcasting signal selected by the tuner 102, thereby generating TS (transport stream).

The separator 104 separates a broadcasting signal (an audio ES (an audio signal) and a video ES (a video signal)) or an SI/PSI from the TS generated by the demodulator 103.

The TS is a multiplexed signal including the broadcasting signal and the SI/PSI. The broadcasting signal is an MPEG-2 broadcasting signal, for example. The broadcasting signal includes an audio ES (Audio Elementary Stream) and a video ES (Video Elementary Stream) which are obtained by encoding a video and a voice. The PSI is information indicating which program is present in the TS and which program each ES contained in the TS belongs to.

The AV decoder 105 decodes the audio ES and the video ES which are separated by the separator 104, thereby generating a video signal and an audio signal. The AV decoder 105 outputs the video and audio signals to the AV output controller 113.

An external storage device such as a DVD recorder or an HDD recorder is connected to the terminal 109. The I/F (interface) 110 serves to transmit/receive data between the external storage device connected to the terminal 109 and the microcomputer 106.

The terminal 111 serves to carry out a connection to the internet. The terminal 111 is connected to a modem which is not shown. The IN (interface) 112 is used to exchange data with a server of an internet service provider through the modem connected to the terminal 111.

The remote control receiver 108 receives an operating signal transmitted by wireless, for example, infrared rays from a remote controller 20 (hereinafter referred to as the remote control 20). The remote control 20 includes various keys required for operating the digital TV 1, for example, a cursor key, an enter key, a character key and a switching key.

A user can switch the video and audio signals provided to the display module 10B and the audio output module 10C by the switching key. In other words, when the switching key is operated, a display of the display module 10B and an audio output of the audio output module 10C are switched into a program selected by the tuner 102, a program recorded on the HDD 101, contents stored in the external storage device connected to the terminal 109 or a Web site obtained through a browser.

The memory 107 stores an operation code of the microcomputer 106 and an analyzing program for analyzing a browser required for reading the Web site and a script file to be used in a display of the Web site.

The browser has an HTTP user agent function for communicating with a Web server to acquire a resource based on a URI (Uniform Resource Identifier) and HTTP (Hypertext Transfer Protocol), a parser function for analyzing the acquired resource depending on a type such as an HTML (HyperText Markup Language), an XHTML (Extensible HyperText Markup Language), an XML (Extensible Markup Language), a text (character) or an image, and a renderer function for regulating an arranging position or a size and thus displaying the text (character) or the image based on the result of the analysis. Moreover, the browser is provided with a script engine such as JavaScript (Java is the registered trademark), and the function of the browser can be extended by a mechanism such as plug-in.

The microcomputer 106 controls the whole digital TV 1. The microcomputer 106 executes an operation code or each program which is stored in the memory 107, thereby implementing the browser function or the script file analyzing function. The details of the analyzing function will be described below.

The AV output controller 113 switches the video and audio signals to be provided to the display module 10B and the audio output module 10C in response to an operating signal received through the remote control receiver 108. Moreover, the AV output controller 113 switches a display mode of the display module 10B (a full-screen display and a dual-screen display) depending on the analysis result of he microcomputer 106.

The display module 10B may be an LCD (Liquid Crystal Display) or a CRT (Cathode Ray Tube), which displays a video corresponding to the video signal provided from the AV output controller 113. The audio output module 10C includes speakers S1 and S2 for outputting a voice corresponding to the audio signal provided from the AV output controller 113.

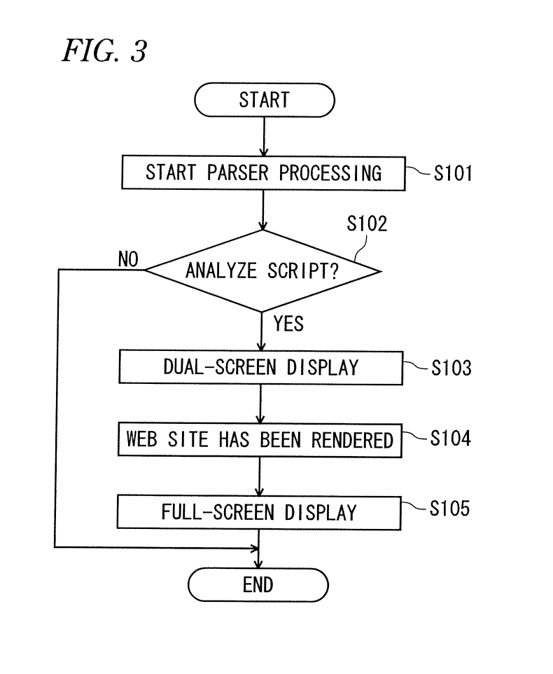

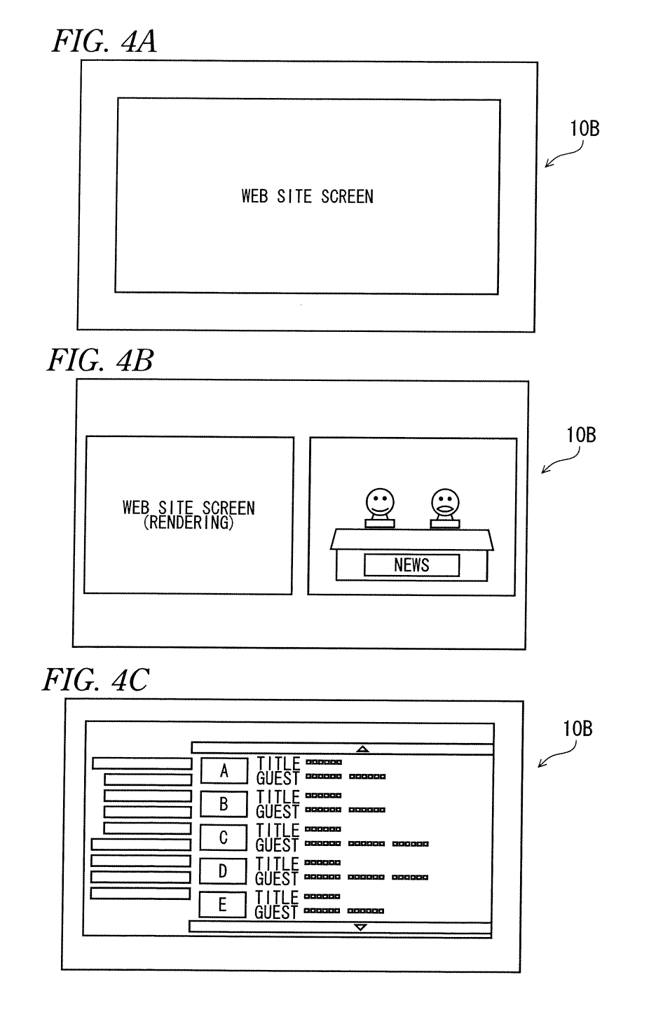

FIG. 3 is a flowchart showing an operation of the digital TV 1 according to the first embodiment. FIGS. 4A to 4C are views showing change in the display mode (the full-screen display and the dual-screen display) in the display module 10B. With reference to FIGS. 3 and 4, the operation of the digital TV 1 according to the first embodiment will be described below in detail. In the following explanation, the description will be given to an operation performed after the browser is started and a Web site of a URL registered as a home page is displayed.

When a user operates the remote control 20 to give an instruction for accessing a URL of a Web site registered as favorite, a URL searched in a search site or a URL input through the operation of the remote control 20, a connection to the URL is started. The browser executes a parser processing for communicating with the Web server to acquire the resource and analyzing the resource depending on the type such as the HTML, the XHTML, the XML, the text (character) or the image (Step S101).

The microcomputer 106 analyzes a script file (for example, a JavaScript file) contained in the resource acquired by the browser (Step S102). More specifically, the microcomputer 106 analyses a file size (a capacity) of the script file and whether a specific library (for example, AJAJA (Asynchronous JavaScript), Dojo Toolkit, jQuery or GWT (Google Web Toolkit) (Google is the registered trademark) is contained in the script file or not.

As a result of the analysis for the script file which is performed by the microcomputer 106, if the file size of the script file exceeds a predetermed size (for example, 200 KByte) or if the specific library is contained in the script file (“Yes” in the Step S102), the microcomputer 106 controls the tuner 102 to select a last channel stored in the HDD 101.

The AV output controller 113 switches from a first display mode in which a Web site is displayed (see FIG. 4A) to a second display mode in which video corresponding to video signals of the channel selected by the tuner 102 and the Web site displayed by the browser are displayed together (see FIG. 4B) (Step S103). Moreover, the AV output controller 113 provides, to the speaker 10C, an audio signal of the channel selected by the tuner 102. The speaker 10C provides, from the speakers S1 and S2, a voice corresponding to the audio signal provided from the AV output controller 113.

When the browser has rendered the Web site (Step S104), the AV output controller 113 switches the display mode of the display module 10B from the second display mode to the first display mode (see FIG. 4C) (Step S105).

If the file size of the script file is equal to or smaller than a predetermined size (for example, 200 KByte) and the specific library is not contained in the script file (“No” in the Step S102) as a result of the analysis for the script file through the microcomputer 106, moreover, the AV output controller 113 continues the first display mode until the Web site is completely rendered.

As described above, in the first embodiment, if the file size of the script file exceeds the predetermined size (e.g., 200 KByte) or the specific library is contained in the script file, that is, if it takes a long time to display the Web site as a result of the analysis for the script file, the AV output controller 113 switches from the first display mode in which the Web site is displayed to the second display mode in which both a program of the last selected channel and the Web site which are stored in the HDD 101 are displayed together. Therefore, it is possible for the viewer to spend a waiting time without feeling bored until the Web site is completely displayed. Thus, the convenience for the user can be enhanced.

In the meanwhile, in case where the Web site is immediately displayed, it is not necessary to switch from the full-screen display to the dual-screen display. For this reason, the screen display is not switched rapidly so that it is possible to prevent the user from feeling uncomfortable. Moreover, since a script file which cannot be cached is analyzed, it is possible to effectively determine whether to switch the display mode.

In the first embodiment, there has been described the case where the script file is analyzed and the switching from the first display mode to the second display mode is performed depending on the analysis result. In the second embodiment, description will be given to a case in which an actual time for displaying the Web site is measured when a certain URL is accessed, and then switching from a first display mode to a second display mode is performed depending on the previously-measured time when the same URL is accessed next time.

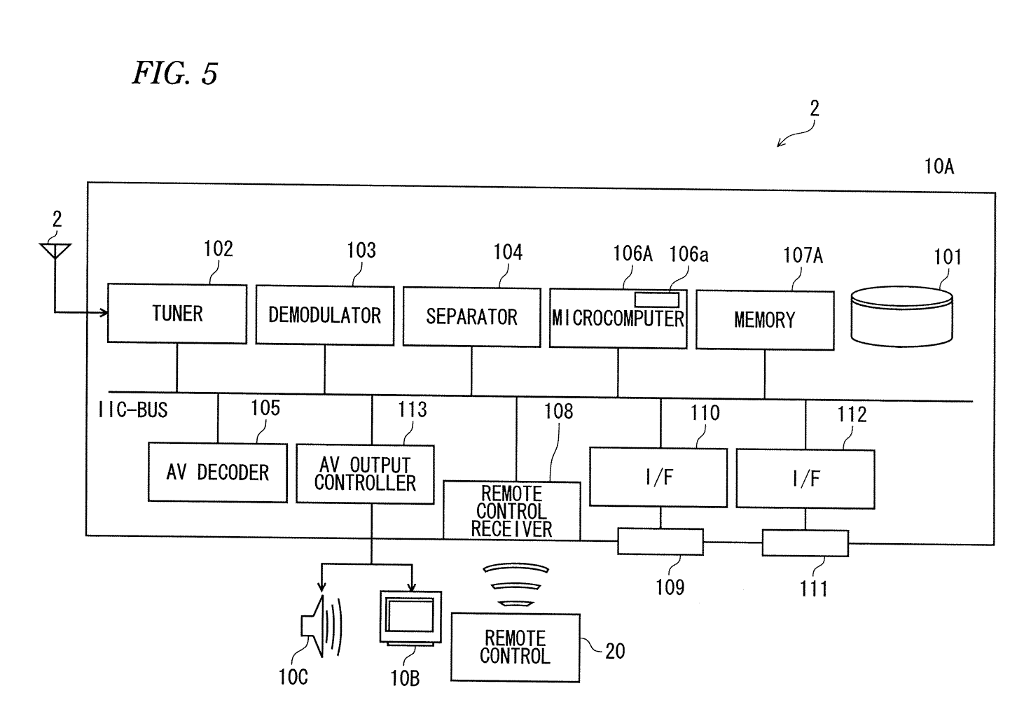

FIG. 5 is a diagram showing the configuration of a video processor according to the second embodiment. In the second embodiment, description will be given to a digital TV 2 as a specific example of the video processor in the same manner as in the first embodiment, and the same elements as those of the digital TV 1 of the first embodiment have the same reference numerals and description thereof will be omitted herein.

The digital TV 2 is different from the digital TV 1 in that a microcomputer 106A is provided with a timer 106a and a list of a URL and a predetermined time N (for example, 10s) are stored in a memory 107A. The memory 107A stores a certain URL if a time T required for actually displaying a Web site exceeds the predetermined time N when the URL is accessed.

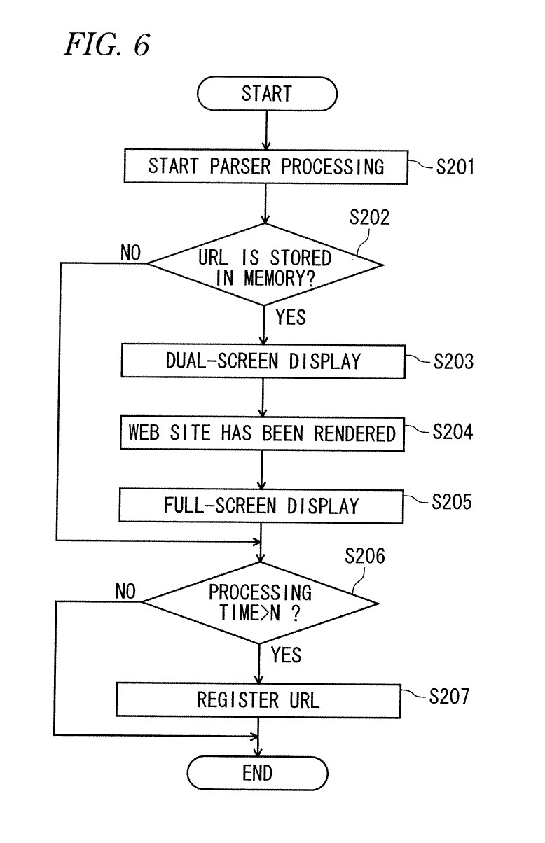

FIG. 6 is a flowchart showing operations of the digital TV 2 according to the second embodiment. With reference to FIG. 6, the operations of the digital TV 2 according to the second embodiment will be described below in detail. In the following explanation, the description will be given to operations performed after a browser is started and a Web site of a URL registered as a home page is displayed.

When a user operates a remote control 20 to give an instruction for accessing a URL of a Web site registered as favorite, a URL searched in a search site or a URL input through the operation of the remote control 20, a connection to the URL is started. A browser communicates with a Web server to acquire a resource, thereby executing a parser processing (Step S201).

When the access to the URL is started, the microcomputer 106A activates the timer 106a and determines whether the URL to be accessed is stored in the memory 107A or not (Step S202).

If the URL is stored in the memory 107A (“Yes” in the Step S202), the microcomputer 106A controls a tuner 102 to select the last channel stored in an HDD 101.

An AV output controller 113 switches a display mode of a display module 10B from a first display mode in which a Web site of the URL is displayed (see FIG. 4A) to a second display mode in which both a program selected by the tuner 102 and the Web site are displayed together (see FIG. 4B) (Step S203). Moreover, the AV output controller 113 provides, to a speaker 10C, an audio signal of the channel selected by the tuner 102. The speaker 10C provides, from speakers S1 and S2, a voice corresponding to the audio signal provided from the AV output controller 113.

When the browser has rendered the Web site (Step S204), the AV output controller 113 switches the display mode of the display module 10B from the second display mode to the first display mode (see FIG. 4C) (Step S205). If the URL is not stored in the memory 107A (“No” in the Step S202), furthermore, the AV output controller 113 continues the first display mode until the Web site is completely rendered.

When the browser has rendered the Web site, the microcomputer 106A stops the timer 106a to compare the time T required from the activation to the stoppage of the timer 106a, that is, the time T required for displaying the Web site with the time N which is stored in the memory 107A (Step S206).

If the time T is longer than the time N (“Yes” in the Step S206), the microcomputer 106A stores the URL of the Web site in the memory 107A. If the time T is equal to or shorter than the time N (“No” in the Step S206), moreover, the microcomputer 106A does not store the URL of the Web site in the memory 107A but the processing is ended.

As described above, in the second embodiment, an actual time required for displaying the Web site is measured when a certain URL is accessed, and the switching from the first display mode to the second display mode is performed if the previously-measured time is longer than the predetermined time when the same URL is accessed next time. Therefore, it is possible to obtain the same advantage as in the first embodiment. Moreover, since it is not necessary to analyze a script file, it is possible to control a processing load of the microcomputer 106A.

In the first and second embodiments, there has been described the case in which a certain Web site is displayed. In the third embodiment, description will be given to a case in which certain contents are downloaded from the Web site. The description will be given to a digital TV 3 as a video processor according to the third embodiment. Since the configuration of the digital TV 3 is the same as the configuration shown in FIG. 2, the same elements have the same reference numerals and description thereof will be omitted herein.

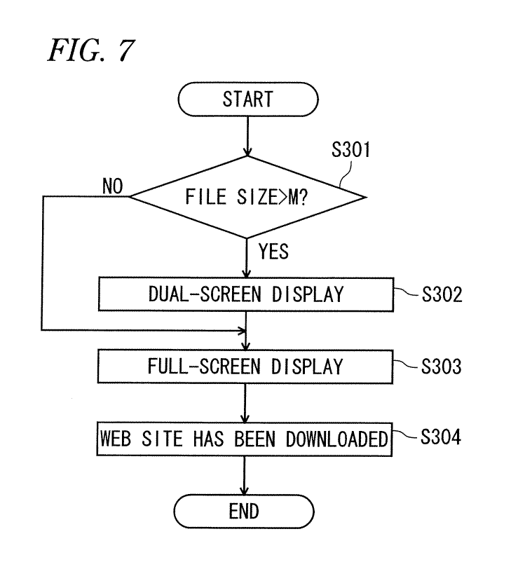

FIG. 7 is a flowchart showing operations of the digital TV 3 according to the third embodiment. With reference to FIG. 7, the operations of the digital TV 3 according to the third embodiment will be described below in detail. In the following explanation, the description will be given to operations performed after a browser is started and a Web site of a URL registered as a home page is displayed.

When a user operates a remote control 20 to give an instruction for downloading contents such as movies or a music from the displayed Web site, the browser starts to download the contents. In this case, a microcomputer 106 analyzes a file size (capacity) of the contents based on an attribute file of the contents downloaded through the browser (Step S301). More specifically, the microcomputer 106 compares a threshold M stored in a memory 107 with the file size of the contents.

As a result of the analysis for the file size of the contents by the microcomputer 106, if the file size of the contents exceeds 1 MByte (“Yes” in the Step S301), the microcomputer 106 controls a tuner 102 to select the last channel stored in an HDD 101.

An AV output controller 113 switches a display mode of a display module 10B from a first display mode for displaying the Web site (see FIG. 4A) to a second display mode for displaying both a program selected by the tuner 102 and the Web site (see FIG. 4B) (Step S302).

When the operation for downloading the contents through the browser is ended (Step S303), the AV output controller 113 switches the display mode of the display module 10B from the second display mode to the first display mode (see FIG. 4C) (Step S304).

As a result of the analysis for the file size of the contents by the microcomputer 106, if the file size of the contents is equal to or smaller than 1 MByte (“No” in the Step S301), the AV output controller 113 continues the first display mode until the Web site is completely displayed.

As described above, in the first embodiment, if the file size of the contents exceeds 1 MByte, that is, if it takes a long time to download the contents, the AV output controller 113 switches from the first display mode in which the Web site is displayed to the second display mode in which both a program of the last channel and the Web site stored in the HDD 101 are displayed together. Therefore, it is possible for the viewer to spend a waiting time without feeling bored until the Web site is completely displayed. Thus, the convenience for the user can be enhanced.

While certain embodiments have been described, these embodiments have been presented by way of example only, and are not intended to limit the scope of the invention. Indeed, the novel methods and systems described herein may be embodied in a variety of other forms. Furthermore, various omissions, substitutions and changes in the form of the methods and systems described herein may be made without departing from the sprit of the invention. The accompanying claims and their equivalents are intended to cover such forms or modifications as would fall within the scope and sprit of the invention.

For example, although the description has been given to the configuration for receiving the digital broadcasting signal in the first to third embodiments, it is also possible to employ an analog broadcasting signal instead of the digital broadcasting signal. Moreover, it is also possible to zoom one of the screens for the Web site and the program of the last channel on the display module 10B in switching to the dual-screen display from the full-screen display.

Furthermore, it is also possible to display the contents or program stored in the external storage device or the HDD 101 in addition to the operation for displaying the program of the last channel in switching to the dual-screen display from the full-screen display. Moreover, the user may be able to set, as the dual-screen display, any of the program of the last channel and the contents and the program which are stored in the external storage device or the HDD 101.

What is claimed is:

1. A video processor comprising:
an access module configured to access a Web site on internet;
an analyzing module configured to analyze information about the Web site so as to calculate processing load for displaying the Web site; and
a display controller configured to switch between a first display mode and a second display mode depending on the processing load, wherein only the Web site is displayed in the first display mode, and wherein both the Web site and a certain image are displayed together in the second display mode.

2. The video processor of claim 1, wherein the analyzing module is configured to calculate the processing load depending on whether a certain library is contained in the information about the Web site or not.

3. The video processor of claim 1, wherein the analyzing module is configured to calculate the processing load depending on a file size of a script file of the Web site.

4. The video processor of claim 1, further comprising:
a memory configured to store a URL of a certain Web site if a time required for displaying the certain Web site exceeds a certain time,
wherein the analyzing module is configured to calculate the processing load depending on whether a URL of the Web site accessed by the access module is stored in the memory or not.

5. The video processor according to claim 1, wherein the analyzing module is configured to calculate the processing load depending on whether a capacity of contents on the Web site exceeds a certain capacity or not.

6. The video processor according to claim 1, further comprising:
a receiver configured to receive a broadcasting signal,
wherein the certain image is generated based on the broadcasting signal.

7. A video processing method comprising:
(a) accessing a Web site on interne;
(b) analyzing information about the Web site so as to calculate processing load for displaying the Web site; and
(c) switching between a first display mode and a second display mode depending on the processing load, wherein only the Web site is displayed in the first display mode, and wherein both the Web site and a certain image are displayed together in the second display mode.
